(19) United States
(12) Patent Application Publication
(10) Pub. No.: US 2026/0133562 A1
(43) Pub. Date: May 14, 2026

(54) ACQUISITION UNIT AND ASSOCIATED METHOD OF ACQUIRING DATA FROM A ROTATING ELECTRIC MACHINE AT A FACILITY

(71) Applicant: VIBROSYSTM INC., Longueuil (CA)

(72) Inventor: Mathieu CLOUTIER, Longueuil (CA)

(21) Appl. No.: 19/380,532

(22) Filed: Nov. 5, 2025

Related U.S. Application Data
(60) Provisional application No. 63/720,229, filed on Nov. 14, 2024.

(51) Int. Cl. G05B 19/418

(52) U.S. Cl. CPC G05B 19/4183; G05B 19/4185

(57) ABSTRACT

The acquisition unit can write values of different parameters of an electric machine at the facility in different channels of a memory; obtain expected variation ranges for the different parameters; for each channel, calculate a difference between one or more recent values and one or more earlier values, compare the difference with the corresponding expected variation range, and trigger the transmission of the recent values, contextualized with a timestamp and a parameter ID, contingent upon the difference exceeding the corresponding expected variation range. The acquisition unit can refresh the one or more recent values in the channels based on a subsequent sampling of the signals; and repeat the steps of calculating, comparing, triggering and refreshing, in accordance with a rate of the sampling.

### FIELD

Embodiments described herein relate to the acquisition of data from sensors coupled to large, e.g. MW-range, rotary electrical machines.

### BACKGROUND

Large, e.g., megawatt-range, rotary electric machines, such as electrical hydro-generators, thermal generators or electrical mills in the mining industry, can be considered “critical” in the sense that the eventuality of downtime can be highly undesirable and associated to significant costs and/or other severe inconveniences. The management of such critical assets is typically associated with certain considerations such as a motivation to avoid failures, limit downtime, and protection against physical intrusions and digital piracy.

### SUMMARY

It will be understood that the operation of acquiring data involves many practical considerations. On the one hand, one may want to collect as much data as possible, such as continuously storing all acquired data in a computer-readable memory for long periods of time, such as weeks or months, to maximize the amount of data which would be available for later retrieval and analysis. In practice, this approach is typically not feasible for various reasons, such as for lack of storage space, limitations pertaining to communications over the local and/or the telecommunications networks, and/or simply due to the fact that it may represent an overwhelming amount of data to deal with when performing an analysis. Indeed, in some cases, having larger amounts of low-relevance, or even non-relevant, data can make it more difficult to zone in on relevant data, which can affect the costs and duration of analysis.

In accordance with some approaches, the decision of when data acquisition is to be performed is based on external requests or pre-programmed schedules. It was found that a different approach where the decision of transmitting or not transmitting a particular data item can be taken by the acquisition unit itself, independently of external requests or pre-programmed schedules, could offer at least some advantages in at least some situations. In accordance with this latter approach, the acquisition unit can continuously, but only for a limited period of time which can be of a few minutes, less than one minute, a few seconds, or less than a second, to name some examples, store all the data acquired from the sensors in an internal memory (e.g., different channels of a register), and perform certain operations on this data while the data is being held in the memory. Indeed, the acquisition unit can be provided with logic to perform these operations. These operations can include determining whether individual data items should be transmitted or not, which can involve calculating a difference between one or more recent values of individual parameters to one or more earlier values of the respective parameters, comparing the difference to an expected variation range for the corresponding parameter, and outputting only the values for which the difference exceeds the variation range. The variation range can be limited to roughly correspond to typical variations which can be expected to occur during steady-state operation of the large rotary machine, thereby outputting any variation from “normal”. It will be understood that the determination can be based on the difference between values of the parameter, as opposed to comparing individual values of the parameter to an alarm threshold. Accordingly, once the determination is made, the acquisition unit transmits the recent values of only the different parameters which have been determined to be outside the expected variation range, and does not transmit the recent values for the different parameters which have been determined to be within the expected variation range.

In accordance with the latter approach, when neither one of the values are determined to be outside the expected variation range, such as may occur during extensive periods when the large electric machine operates in a steady state of operation, the acquisition unit does not transmit any values. On the other hand, when many or potentially all values are determined to be outside the expected variation range, such as may occur during transient conditions, such as startup or shutdown of the large electric machine, the acquisition unit can transmit a large amount of data.

Interestingly, using the latter approach, when looking into the data to perform analysis, it can be possible to deduce values of some of the parameters at points in time when these values were not transmitted by the acquisition unit. Indeed, knowing that the acquisition unit would have transmitted values if they had changed significantly, beyond the expected variation range, one can deduce from the silence of the acquisition unit that the value of a parameter at a given point in time corresponds substantially (i.e., within the expected variation range) to the latest value of that parameter that had been transmitted before that point in time. Accordingly, time-series data can be reconstructed for any point in time, and analysis may be performed at any point in time, notwithstanding the fact that values of some or even all of the parameters had not been transmitted at that point in time.

Operating in this mode by default may lead to large amounts of data being transmitted in certain transient conditions, which may carry a mix of advantages and inconveniences. For instance, one can imagine a scenario where samplings are triggered by thresholds set in an alarm system, but where the machine operator closes the alarm system, and thus the automated sampling triggers, at startup and shut down, to avoid being overwhelmed by numerous alarms which may be presumed irrelevant in the context. In this scenario, data pertaining to the starting or shutting down conditions of the rotary electric machine may not be made available to the analysts, for the sole reason that the triggers to acquire the data have been deactivated by the machine operators. Accordingly, using a method such as presented above in which only, and all, data which varies beyond the expected variation range is transmitted, can allow to obtaining data pertaining to these transient starting or shutting-down conditions, and may be perceived as an advantage from this point of view.

Moreover, the inconveniences of such large amounts of data at such periods of time can be alleviated by using certain techniques which can allow the compressing of larger amounts of lower-level data into smaller amounts of higher-level data. The higher-level data may be more relevant from the point of view of analysis than the lower-level data and occupy less memory space or bandwidth. The compression can be performed by the acquisition unit itself, in real-time or near real-time, such that in some cases, the acquisition unit transmits the smaller amount of higher-level data instead of the larger amount of lower-level data, when the data is determined to have varied outside the expected variation range. In such cases, the comparison between the one or more recent values and the one or more earlier values can be based on either the lower-level data or the higher-level data. In some embodiments, basing the comparison on the lower-level data may be more convenient as it may allow to save the processing of the higher-level data to situations where the higher-level data is used/transmitted.

Accordingly, the acquisition unit can write values of different parameters of an electric machine at the facility in different channels of a memory; obtain expected variation ranges for the different parameters; for each channel, calculate a difference between one or more recent values and one or more earlier values, compare the difference with the corresponding expected variation range, and trigger the transmission of the recent values, contextualized with a timestamp and a parameter ID, contingent upon the difference exceeding the corresponding expected variation range. The acquisition unit can refresh the one or more recent values in the channels based on a subsequent sampling of the signals; and repeat the steps of calculating, comparing, triggering (or more plainly outputting) and refreshing, in accordance with a rate of the sampling.

In accordance with one aspect, there is provided an acquisition unit comprising: input ports connectable to receive signals from sensors coupled to an electric machine having a peak power of at least 100 kW; one or more output ports; a clock; a memory storing parameter IDs of different parameters of the electric machine, channels corresponding to different ones of the parameter IDs, variation data including one or more expected variation ranges for the different parameter IDs, and instructions; a hardware processor which executes the instructions to, in sequence: acquire values for the different parameters based on the signals from the sensors, including writing the values in corresponding ones of the channels; for each of one or more of the channels, calculate a difference between one or more recent values of the values, and one or more earlier values, of a corresponding parameter ID, compare the difference with the expected variation range for the corresponding parameter ID, and trigger the output of the one or more recent values contextualized with a timestamp and the corresponding parameter ID, contingent upon the difference exceeding the corresponding expected variation range; refresh the values in the channels based on a subsequent acquisition of the values based on the signals from the sensors; and repeat in sequence said calculate, compare and trigger for each of different ones of the channels, and said refresh, in accordance with a sampling rate.

In accordance with another aspect, there is provided a computer-implemented method of acquiring data at a facility, the method comprising: writing values of different parameters of an electric machine at the facility in different channels of a memory including sampling signals received from sensors coupled to the electric machine, and writing one or more recent values and one or more earlier values of a corresponding parameter in each channel; obtaining variation threshold data pertaining to expected variation ranges for the different parameters; for each of one or more of the channels, calculating a difference between the one or more recent values and the one or more earlier values, comparing the difference with the corresponding expected variation range, and triggering the transmission of the one or more recent values, contextualized with a timestamp and a parameter ID, contingent upon the difference exceeding the corresponding expected variation range; refreshing the one or more recent values in the channels based on a subsequent sampling of the signals; and repeating said calculating, comparing and triggering for each of different ones of the channels, and said refreshing, in accordance with a rate of the sampling.

Many further features and combinations thereof concerning the present improvements will appear to those skilled in the art following a reading of the instant disclosure.

### DESCRIPTION OF THE FIGURES

In the figures,

FIG. 1A is an elevation view of a first example of a large electric machine;

FIG. 1B is an elevation view of a second example of a large electric machine;

FIG. 1C is a schematic view of an example system including components of monitoring equipment associated to a large electric machine;

FIG. 2 is a schematic of an example flow of information between the sensors and a graphical user interface;

FIG. 3A is a first graph presenting two example sets of data;

FIG. 3B is a second graph presenting two example sets of data;

FIG. 3C is a third graph presenting two example sets of data;

FIG. 4 is a block diagram of an acquisition unit;

FIG. 5 is a block diagram showing channels of a memory and visually depicting the movement of data in real-time or near real-time based on a refreshing rate which can be associated to a sampling rate of the sensors;

FIG. 6 is a flow chart showing how decisions on whether values will be transmitted or not can be taken on a channel-per-channel basis, in real-time or near real-time;

FIG. 7A and FIG. 7B are a block diagram and a flow chart, respectively, showing another example of how the determination can be made;

FIG. 8 is a block diagram showing how values of a higher-level parameter can be computed based on values of one or more lower-level parameters;

FIGS. 9A and 9B are provided to provide a visual representation of how a higher-level minimum point per pole parameter can be computed;

FIGS. 10A and 10B are provided to provide a visual representation of how a higher-level s vector parameter can be computed;

FIGS. 10C and 10C are provided to provide a visual representation of how a higher-level one s vector value per pole parameter can be computed;

FIG. 11A and FIG. 11B are provided to provide a visual representation of how a higher-level frequency peak coordinate parameter can be computed;

FIG. 12 is a block diagram of an example computer.

### DETAILED DESCRIPTION

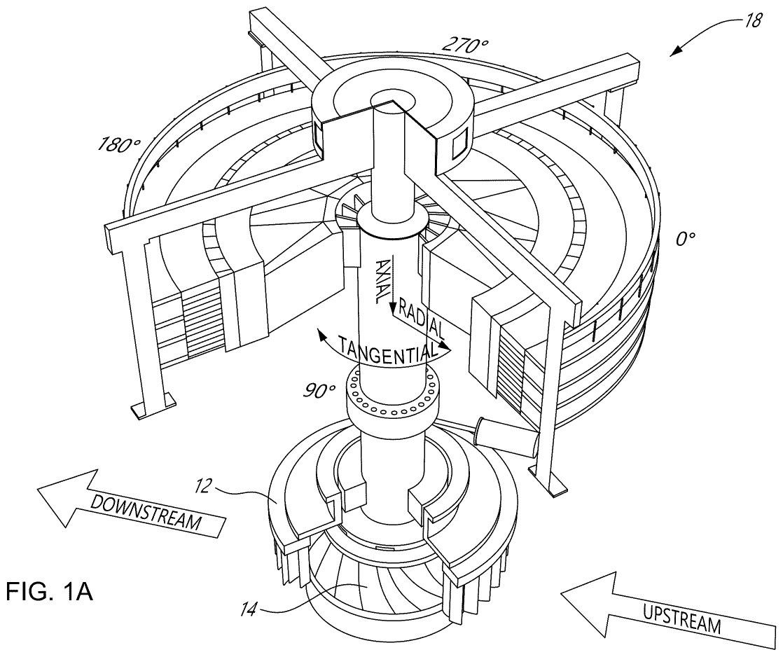

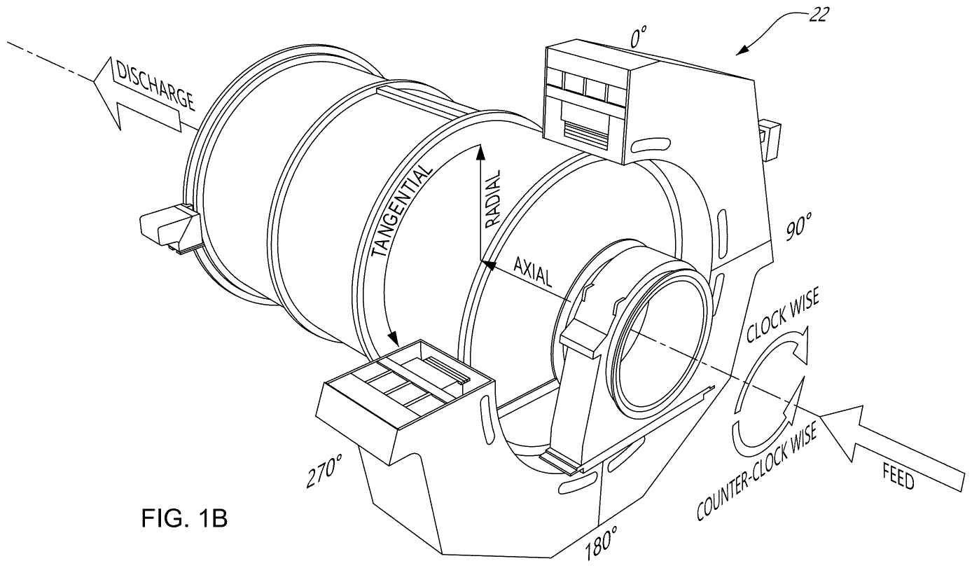

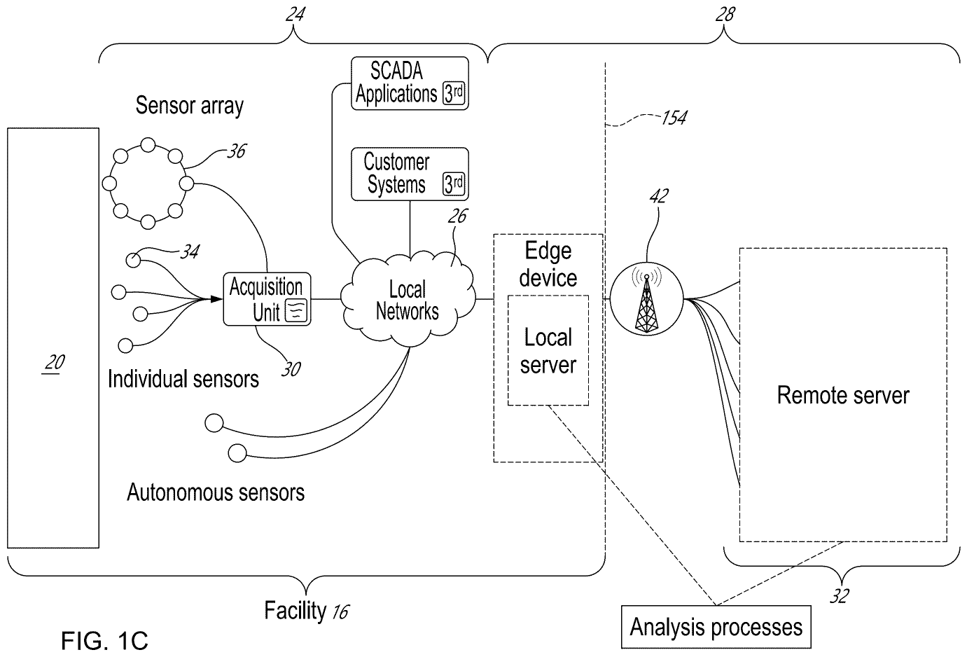

FIG. 1A shows an example of a large electric machine which, in this embodiment, is embodied as a generator. More specifically, the example electric machine is a Kaplan-type turbine 18. As depicted, the Kaplan-type turbine 18 has a stator 12 and a rotor 14 which is rotatably coupled to the stator and which rotation can be driven by an incoming flow of liquid along orientation D. Gas turbine generators and steam generators may also be embodied as large rotary electric machines.

FIG. 1B shows another example of a large electric machine embodied here as a Semi-Autogenous Grinding (SAG) mill 22. In this embodiment, the SAG mill has a rotor and a stator and is powered by electricity.

Both the Kaplan-type turbine 18 and the SAG mill 22 are examples of large electric machines. Referring to FIG. 1C, large electric machines 20 are located at premises which will be referred to herein as facilities or industrial plants, and are typically equipped with elaborated monitoring equipment. A given facility 16 can have one or more electric machine 20, and each electric machine 20 can have dedicated equipment while some of the monitoring equipment can be shared with more than one machine. The expression “large” here refers to the power range, and typically also implies a relatively large volume. The power range can be indicative of a criticality of the machine, in the sense that downtime for a machine having a greater power is typically more “costly” (e.g. in terms of lost profits or other inconveniences) than a smaller power machine, making the business case of investing to reduce the likelihood or duration of downtime often easier to make than on smaller electric machines. A given large rotary electric machine 20 can be in the range of hundreds of kilowatts (KW), in the range of megawatts (MW), or greater, for instance, depending on the embodiment. The monitoring equipment and the electric machine(s) 20 can be local to the facility 16, such as local to an electrical power plant or a mining milling plant.

In the embodiment schematically presented in FIG. 1C the facility 16 has one or more electric machines 20 and monitoring equipment 24. The monitoring equipment 24 can include sensors, acquisitions units and higher-level applications running on computer resources such as SCADA applications and systems owned by the plant owner (customer systems), and one or more local network 26, all of which can operate on hardware located at the facility 16. The monitoring equipment can also include a local server, for instance where the acquired data can be stored. The one or more local networks 26 via which the local hardware communicates with one another can be of the “operational technology” (OT) type and can operate based on Industrial Internet of Things (IIOT) technology for instance. Other local networks can be present or absent, and connected to the acquisition unit or disconnected from the acquisition, such as an Information Technology (IT) network such as Ethernet for instance. Elements constituting the local network(s) can be wired, wireless, or hybrid.

In some other embodiments, rather than, or in addition to, being stored locally, the acquired data can be stored remotely, such as on a remote server 32. In some cases, the acquisition unit 30 may communicate directly with the remote server via the telecommunications network, whereas in other embodiments, an edge device may be used, and the acquisition unit 30 may transmit the data to the edge device via the local network(s), and the edge device, in turn, can coordinate the transmission of the data to the remote server via the Internet. As such, the edge device can be positioned at a boundary 154 between the local network 26 and the telecommunications network 152.

The monitoring equipment 24 can include sensors configured to monitor the status (e.g. health) of the electric machine 20. Sensors can be provided in various forms, such as discrete sensors 34, sensor arrays 36, autonomous (e.g. wireless) sensors 38, etc.

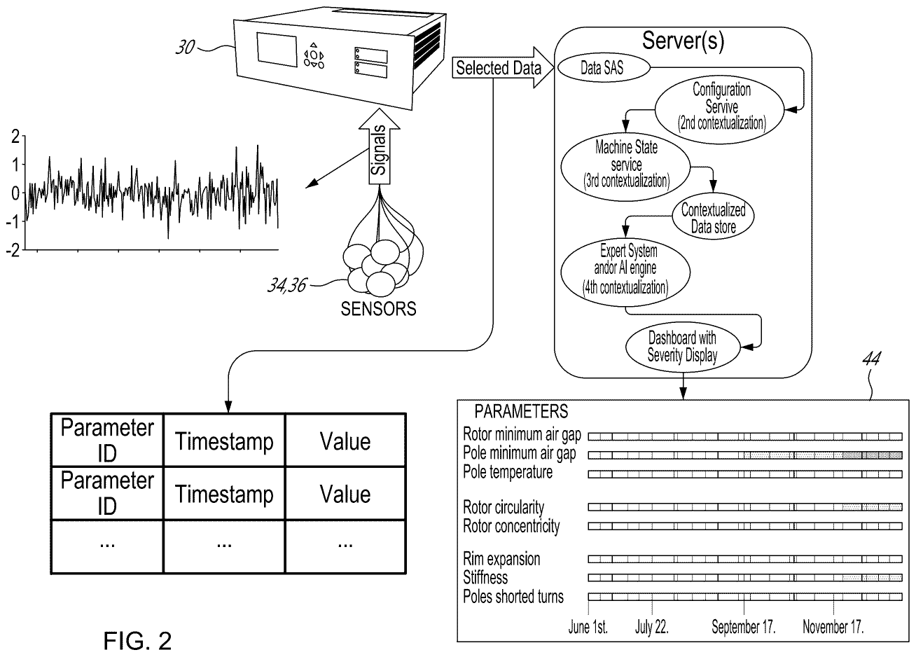

Independently of where the data is stored, the general information flow can be as exemplified in FIG. 2, where the sensors measure real-world physical conditions and generate analog signals representing time-varying values for different parameters associated with the large rotary electric machines. Acquisition units 30 are used to acquire data from the sensors 34, 36, which typically involves sampling the signals and converting the resulting samples into sequences of digital numeric values (sampled values) that can be manipulated by a computer. The resulting data can be time-series data representing the evolution of the values of the different parameters over time, although as will be seen, in some cases, only a single value of a parameter corresponding to a given time may be maintained in the memory of the acquisition unit at any given point in time, and for some other parameters, only values corresponding to two points in time may be maintained in the memory of the acquisition unit at any given point in time. Newer values can be overwritten onto older values in the memory. The data outputted from the acquisition unit can be time-series data and can be used to perform an analysis of the health of the rotary electric machine. Based on this analysis, certain important decisions may be taken, such as scheduling maintenance at a later time, or even interrupting the operation of the rotary electric machine to avoid a potential failure.

Performing an analysis of the data typically involves the work of a professional human referred to in the field as an analyst. The work of the analyst may be facilitated by using software tools. Various forms of software tools may be used, such as user interface technologies to facilitate the display, search, or interaction with the data, and alerts which can direct the analyst's attention to data associated to segments of time when the rotary electric machine was operating outside predetermined operating conditions.

Perhaps of first and foremost importance is that data needs to be contextualized in order to be of use in an analysis. Indeed, a number of values, without an indication of what these values represent or when they were acquired, is useless. Referring to the example presented in FIG. 2, there can be different layers of contextualization, and a first layer of contextualization is typically performed by the acquisition unit 30 itself, such as by appending to each one of the values it outputs an identifier of the parameter which it pertains to, and a timestamp which can correspond to the time indicated by the clock at the time of acquisition. The identifier can be used to provide information as to what the value represents, whereas the timestamp can be used to provide information as to when the value was sampled.

One way of keeping track of what the value represents is, on the one hand, to keep a configuration file indicating information such as what the different sensors are and where different sensors were mounted at the time of assembly, and on the other hand, to keep track of which sensor each data item originates from. This can allow the subsequent contextualization of where on the machine the data originates from and what physical measurements are indicated based on the information of which sensor the data item originates from and the information in the configuration file. Indeed, each sensor can be said to measure real-world physical values pertaining to a given parameter associated with the large rotary electrical machine. Such parameters can be referred to herein as first-level parameters, since they relate to things which are directly measured by the sensors, and can be tracked more specifically by identifiers of the sensors, for instance. In some other cases, values of certain parameters can be computed based on two or more values of first-level parameters. Examples will be provided below. Such computed values can be said to pertain to higher-level parameters, or composite parameters, and can be tracked more specifically by identifiers of such higher-level parameters. Both sensor IDs and higher-level IDs can be said to constitute parameter IDS.

Typically, the data items outputted by the acquisition unit will have a data format, an example of which is presented in FIG. 2. In this example, the data format of the data items includes the parameter ID and the timestamp in addition to the value. The different fields of the data format can be in a different order in other applications, as long as the order is known at the time of analysis to allow interpreting the different fields.

The data items can be formed into the associated format immediately after sampling. For instance, they can be stored in the channels of a register in the illustrated format, by appending the parameter ID and a timestamp to the value at the time of acquisition. However, when values are stored in a channel of the register which is dedicated to a specific parameter, any value in that channel can be presumed to be associated to the associated parameter, and the parameter ID may be deduced and appended later, such as immediately prior to output for instance. Similarly, if the output of values concerning different parameters is divided into corresponding channels, during transmission, association with the parameter ID may be inherent in the mode of communication, and the data items themselves may not be labeled with the parameter ID. The parameter ID information can be deduced at reception based on the known mode of communication.

Similarly, a typical way of providing a timestamp is to refer to a clock integrated to the acquisition unit, and to append the value indicated by the clock to the newly acquired value when storing that value in memory. However, the timestamping as well may be inherent. Indeed, if, for example, the rate of sampling is constant and known, the relative amount of time elapsed between two values in a given sequence can be deduced by counting the number of values acquired in between and based on the knowledge of the sampling rate. Alternatively, if many values are sampled at the same time, and the information that the group of values were sampled at the same time is preserved, appending the timestamp to the group as opposed to to individual values of the group may be found more efficient.

Accordingly, there are different ways in which first-level contextualisation may be performed by the acquisition unit 30 in different embodiments, but in many embodiments, the acquisition unit 30 will be configured in a manner to, at minimum, preserve information allowing to determine what the value refers to, and the moment in time when this value was acquired. In this context, “what the value refers to” can include information such as from which sensor or computing process it was acquired, where is this sensor positioned on the machine, what the outputs of this sensor or process means, etc. In a first level contextualization by the acquisition unit, preserving information allowing to determine what the value refers to may only involve keeping track of an originating sensor ID or an originating process ID, and more information about what the value refers to may be preserved in a separate database, to be retrieved based on the ID. First level contextualization can, of course, include additional elements of data in some embodiments, such as an ID of the acquisition unit itself, an ID of the module, an ID of the channel, a reference vs a synchro which allows to locate the measurement on a rotating part, etc.

If only first-level contextualization was performed prior to making the data available for analysis, there can remain a significant burden of zoning in on data of relevance amongst the amount of available data. Additional levels of contextualization can be provided to facilitate the analysis process.

For instance, some information pertaining to what will be referred to herein as a second level of contextualization can be collected at the time of assembly or of reconfiguration of the sensors, for instance. This information can be entered in a database and made available for a second level of contextualization by what will be referred to herein as a configuration service. Such information can include sensor information, such as sensor location, part monitored by a sensor, sensor output details, or information as to which sensor (sensor ID) is associated with which acquisition unit, which module, which channel, etc. Such information can further include information pertaining to the large rotary electrical machine to which the sensor is coupled, for instance, such as nominal speed, nominal air gap, number of poles, number of bars, dimensions, etc. Second-level contextualization may be performed on the data which has previously been outputted by the acquisition unit, such as in a server, whereas in certain cases, certain elements of higher-level contextualization may be provided by the acquisition itself, though there is typically an inconvenience associated to requiring too much computing power or memory of the acquisition unit itself, which will often make it more convenience for computer-intensive functions to be performed by a separate computer, such as a local or remote server.

Moreover, some information pertaining to what will be referred to herein as a third level of contextualization may be calculated or otherwise inferred based on the data contextualized by the first and/or second levels of contextualization, and/or by additional data. Such information can include information pertaining to the state of operation of the rotary electrical machine, for instance, such as rotation speed (which may be computable from synchro or air gap sensor data for instance), temperature, magnetic field, etc.

Third level contextualization can be important for the purposes of simplifying or increasing the efficiency of analysis, be it an analysis performed by a professional human, or an analysis performed by automated means such as algorithms or trained engines (artificial intelligence).

In some embodiments, third level contextualization may be performed post-acquisition, e.g., at a local or remote server, based on automated functions implemented by execution of associated computer-implemented instructions, which may compute third level contextualization information based on the first and/or second levels of contextualization and on known relationships between these different elements of data. Interestingly, performing third level contextualization independently from any inputs of a third party system or SCADA can provide an additional benefit of adding a layer of protection against risk of digital piracy, or otherwise alleviating practical inconveniences associated with the coordination between a system operator and a person in charge of acquiring data.

Analysis may provide an even higher level of contextualization. For instance, algorithms may be adapted to classify phenomena identified in the data in terms of severity, or trained engines may be used to perform automated pattern recognition, which may detect, in the data, signatures which, when taken into consideration with machine state of operation, can allow to identify potentially abnormal changes.

Returning to FIG. 2, it will also be noted that graphical user interface tools can also be provided to facilitate interpretation of data by a human, such as an analyst, machine owner, or machine operator. In the example presented in FIG. 2, time-series data pertaining to severity levels, as opposed to measured values, can be produced as an output of 4^{th}-level contextualization, and graphically displayed, as a dashboard on a display screen of a computer, as timelines for different ones of a number of parameters of the large electrical rotary machine. In this manner, a human can easily visualize, at a glance, the evolution of assessed severity levels of many different, and in some cases relatively high-level, parameters over time, with a single glance at a computer display screen.

Upstream of any higher-level functionality, however, may lie the challenge of increasing the quality of the data which is outputted from the acquisition unit 30. One approach to limit the amount of data acquired and stored to a feasible amount is to set a schedule of when sampling of the data is to be acquired. For instance, a “sampling” can consist of acquiring all data acquired, from all channels, for a limited period (typically less than one minute, e.g., 20 seconds). Sampling can be scheduled at regular intervals, upon request by a local or remote user or system, or when certain conditions are met, for instance. To take an audio-visual analogy, sampling can be compared to taking a short video, consisting of a large number of frames, or pictures. In this analogy, the individual frames consist of a number of values acquired from different sensors at a given point in time rather than of pictures, and the sequences of all these values over time can represent a large amount of data, particularly when the sampling rate is in the millisecond range. It will be noted that although sampling can have the advantage of concentrating the amount of data outputted by the acquisition unit to the specific time periods associated with a predetermined schedule or a specific request, there is no guarantee that the predetermined schedule or the specific request will coincide with a time when acquiring the data is relevant. Moreover, when a sampling is performed, there is nothing inherent to the data collected by the sampling which would direct an analyst's attention to a specific parameter. For example, in the context of a scheduled sampling, to be exhaustive, an analyst may need to analyse and go through the data pertaining to several different parameters for which values have been collected, to try to see if anything seems unusual or potentially problematic, which can represent a source of delay and of costs.

Another approach to limit the amount of data acquired and stored to a feasible amount is to set conditions of when the data is to be acquired, such as when samplings are to be performed. For instance, absolute thresholds, or “alarms”, can be set for values of different parameters being monitored, and sampling may be triggered when either one of the absolute thresholds are met, based on a comparison between a current value of the parameter and the threshold value for that parameter. An advantage of triggering sampling based on an alarm can be that, when the information pertaining to the nature of the alarm is preserved in the data which is outputted from the acquisition unit, stored and made available for analysis, this information may direct the attention of the analyst to a specific sub-category within all the data which has been collected. Moreover, in some cases, alarm engines are embodied as units distinct from the acquisition units, and connecting acquisition units to alarm engines may pose certain risks associated with digital piracy.

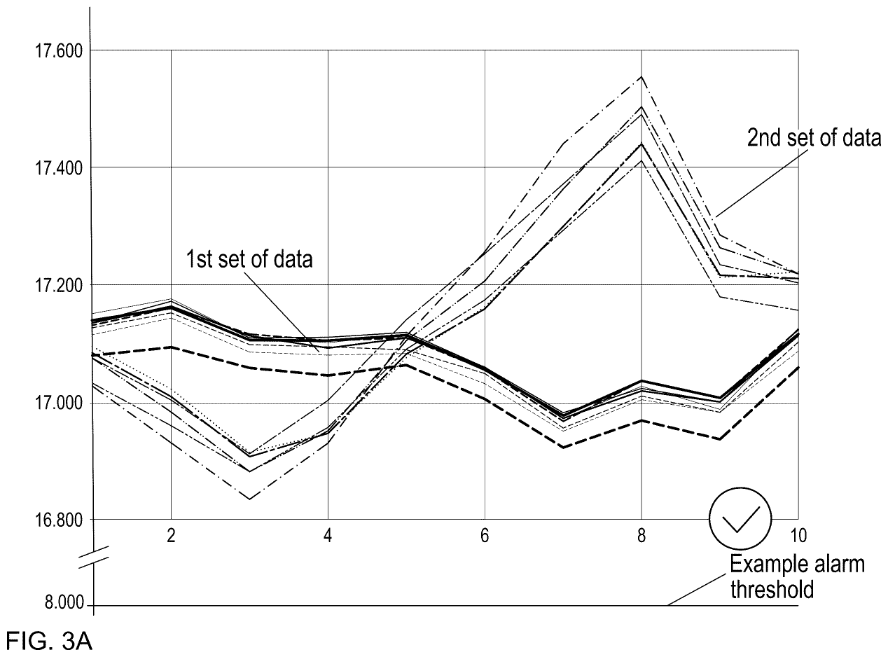

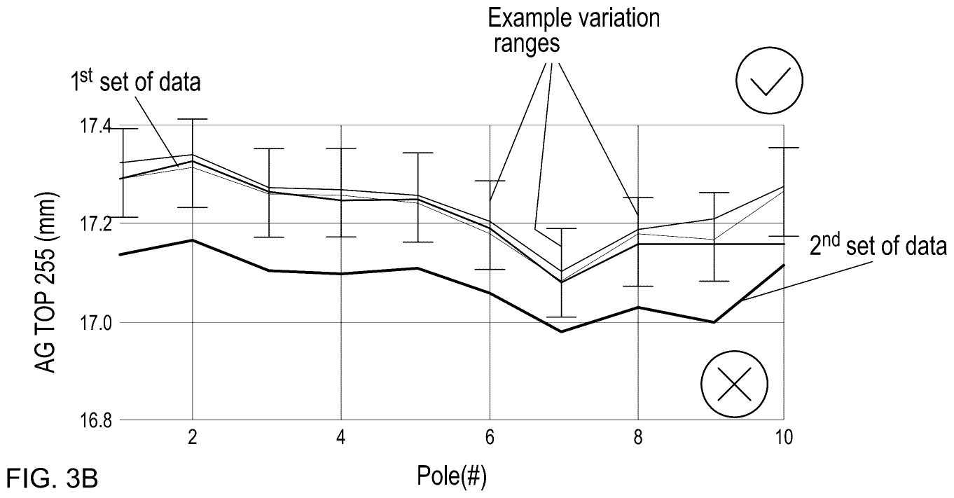

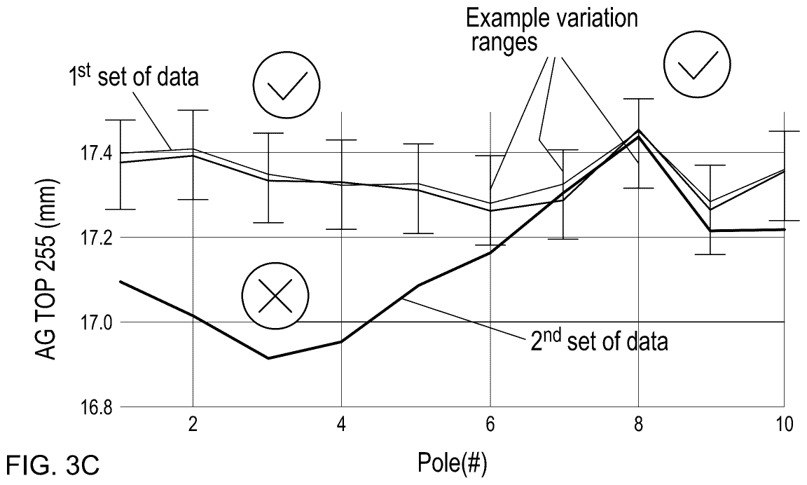

FIG. 3A presents an example of data which may be acquired by an acquisition unit based on signals outputted by sensors coupled to a large rotary electric machine. In this example, two sets of data are shown, which form significantly different patterns in the graphical representation which was made to facilitate interpretation by a human. The two sets of data were acquired at two different moments in time, separated by an interval of a number of weeks. Each one of the two sets presents data based on measurements taken by 10 different air gap sensors over a number of revolutions, with different ones of the air gap sensors coupled to different poles of the large rotary electric machine. Accordingly, each one of the two sets of data includes a number of lines which have generally similar shape and represent individual revolutions.

The values displayed by the lines in the graphs correspond to minimum air gap per pole. Both sets of data correspond to periods of time during which the rotor was rotating at nominal speed. One can see that there are some relatively minor variations in the values captured on the same machine, with the same sensors, and at the same speed, but for different ones of the rotations, as evidenced by the distinctness between individual lines of each set. There are more major, very visible, differences between the general pattern formed by the lines of the first set and the general pattern formed by the lines of the second set. The first set of data was taken prior to a maintenance operation, and the second set of data was taken after a maintenance operation, and prior to a critical failure.

Alarms are typically set in a manner to detect potentially problematic situations, but on the other hand, there can be a significant motivation to reduce the likelihood of false alarms, imposing a limitation on detecting more subtle variations. One way of setting an alarm is to set a specific threshold for minimum air gap values. An example of such a threshold is presented in FIG. 3A as a horizontal line. Such a threshold may be set based on a generic specification of the machine, for instance. In the example illustrated, it will be noted that neither one of the sets of values contain a value which exceeds the threshold. As such, neither one of these sets of values would trigger the alarm, and in such a scenario, there would be no trigger to trigger the sampling. However, the difference in the patterns formed by the two different sets of data is very easy to see once one's attention is focussed on it, and had one's attention been directed to it, critical failure may have been averted. However, in the absence of an alarm, there may be no motivation to acquire or transmit these sets of data, or to request an analysis, and to the contrary, the costs associated with an analysis may not be deemed justified. Accordingly, notwithstanding the advantages of using alarms/absolute thresholds as triggers to acquire data, there remains limitations inherent to this approach.

It was found that yet another approach could offer at least some advantages in at least some situations. This other approach can involve continuously, but only for a limited period of time which can be of a few minutes, less than one minute, a few seconds, or less than a second, to name some examples, storing all the data in a memory (e.g., buffer register) of the acquisition unit, and performing certain operations on this data while it is being held in the memory. The acquisition unit can be provided with logic to perform these operations. These operations can include calculating a difference between one or more recent values of individual parameters to one or more earlier values of the respective parameters, comparing the difference to a variation range for the corresponding parameter, and outputting only the values for which the difference exceeds the variation range.

FIG. 3B presents a visual representation of such expected variation ranges. The variation range can be limited to roughly correspond to the typical variations which occur during steady-state operation of the large rotary machine. For instance, a first set of data shown as three grouped lines on FIG. 3B presents data acquired from the air gap sensors during three successive turns while the machine operates at a slow speed, such as may occur during startup or shutdown, for instance. From one turn to another, the shape of the lines can be seen to vary minutely, well within the expected variation range. A second set of data is shown as a single line on FIG. 3B, presenting data acquired from the corresponding air gap sensors during a single turn while the machine operates at nominal speed, such as may occur during typical operating conditions of the machine for instance. This second set of data can be seen to exceed the expected variation range. Accordingly, if the values of the second set of data are compared to the expected variation ranges, they will all be deemed to be outside the expected variation range, in this case, and accordingly, they will all be outputted by the acquisition unit. The expected variation ranges can then be adjusted based on the values of the second set of data, which have been outputted, and subsequent values can be compared to the adjusted expected variation ranges. At nominal speed, the values acquired from subsequent turns can be similar to the values presented in the first set of data of FIG. 3A, and not be outputted until the values begin to vary again beyond the expected variation ranges.

Accordingly, once the determination is made, the acquisition unit transmits the recent values of only the different parameters which have been determined to be outside the expected variation range, and does not transmit the recent values for the different parameters which have been determined to be within the expected variation range.

In accordance with the latter approach, when neither one of the values are determined to be outside the expected variation range, such as may occur during extensive periods when the large electric machine operates in a steady state of operation, the acquisition unit does not transmit any values. On the other hand, when many or potentially all values are determined to be outside the expected variation range, such as may occur during transient operating conditions, such as startup or shutdown of the large electric machine, the acquisition unit can transmit a large amount of data.

Looking back specifically at the example presented in FIG. 3A, it will be understood that while neither the first set nor the second set of values would have triggered the alarm threshold, one or more values of the second set of values would nonetheless have been outputted, in a contextualized manner, by the acquisition unit. More specifically, during the shut down which preceded the maintenance, and the subsequent startup of the machine to eventually bring it back to nominal rotation speed, a plurality of data points will have been transmitted by the acquisition unit, ending with data points which may be deemed to be close to the current operating conditions, even if these current operating conditions are days or weeks after the receipt of the last data point. Accordingly, this provides points of data which may serve for analysis.

This latter aspect is further exemplified in FIG. 3C where a first set of data corresponds to two turns having taken place at a slow rotation speed, during startup subsequently to maintenance, and a second set of data presents one turn having taken place at a nominal rotation speed, subsequently to startup. Several of the points of data in the second set of data can be seen to exceed the expected variation ranges tied to the first set of data, and would have been outputted by the acquisition unit, although some of the points of data, namely poles 7, 8 and 9, can be seen to have remained within the expected variation ranges, and may not have been outputted by the acquisition unit.

In an alternate embodiment where, for instance, one or more data point has unexpectedly varied in a manner to exceed the expected variation range, outputting solely these one or more data points in a contextualized manner, and in a context where the analyst knows it would not have been transmitted would it not have been determined to have varied from a previous value in excess of the expected variation range, inherently provides an indication to the analyst that he may want to analyze specifically that piece of data, or that region of the machine, as opposed to providing full sampling data to an analyst and asking him if he sees anything unusual somewhere in this ocean of data.

Moreover, and interestingly, when performing analysis based on data acquired with the latter approach, it can be possible to deduce values of some of the parameters at points in time when these values were not transmitted by the acquisition unit. Indeed, knowing that the acquisition unit would have transmitted values if they had changed significantly, beyond the expected variation range, one can deduce from the silence of the acquisition unit that the value of a parameter at a given point in time corresponds substantially (i.e., within the expected variation range) to the latest value of that parameter that had been transmitted before that point in time. Accordingly, analysis may be performed at any point in time notwithstanding the fact that values of some or even all of the parameters had not been transmitted at that point in time. In this context, for instance, an indication of the entire second set of data may be available, allowing to reconstitute the overall pattern of the second set of data over all poles, for a point in time where only a value for one of the poles is outputted. For instance, a visual display such as presented at FIG. 2 can be generated including generating longer-term time-series data and graphically representing them as continuous timelines for various parameters associated to the machine, based on the values which may have been outputted only sporadically by the acquisition unit.

It will be noted that transmitting only the values which have been determined to have varied more than their expected variation range, in a contextualized manner (namely in a manner to identify the source of the data) can additionally provide the benefit of providing, inherently, an indication of where attention may be directed during analysis. Indeed, inherently, a value which has been determined to have varied more than its expected variation range may raise an investigation of why this value has varied more than its expected variation range, and the answers to this investigation may allow to detect a behavior or situation which requires maintenance or urgent attention in time to avert a catastrophic failure.

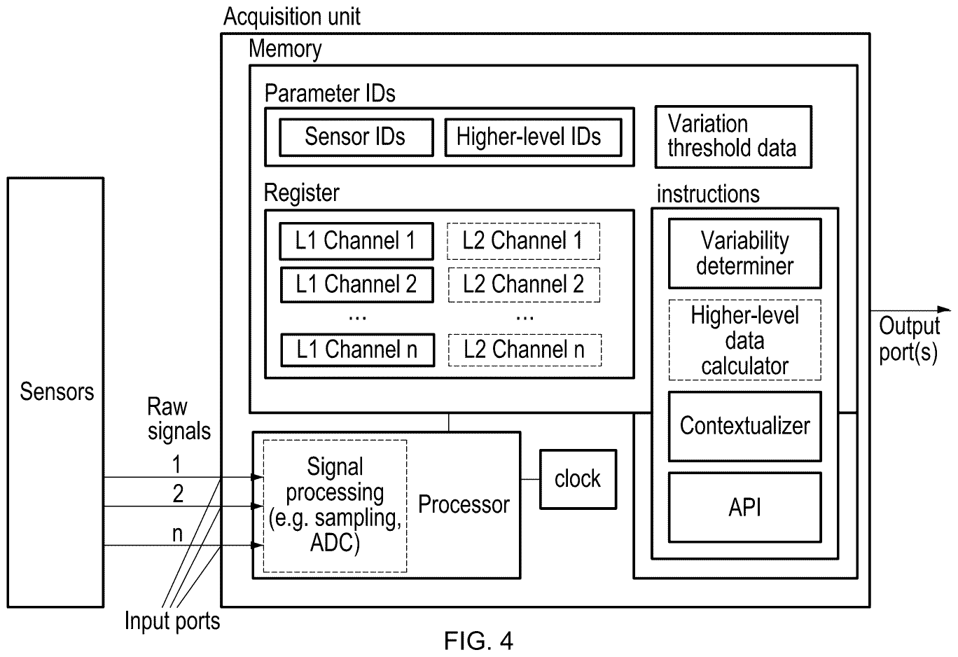

Examples pertaining to practical considerations associated with operating in this mode will now be presented with reference to FIGS. 4 to 6.

FIG. 4 presents a block diagram of an acquisition unit which can be adapted to operate in this mode of operation. More specifically, the acquisition unit can have a number of input ports connected typically in a wired manner, though optionally in a wireless manner, to corresponding sensors or groups of sensors which can generate raw signals during operation of the large rotary electric machine. The acquisition unit can have a computer, including a processor and a memory. The acquisition unit can have a group of functions dedicated to signal processing, which can be said to generally be performed by hardware and optionally software which will be considered here to form part of a “processor”. Such functions can include sampling of the raw signals and converting the sampled values from analog to digital (for which one or more analog to digital converters—ADCs—can be provided as part of the processor).

The memory can have a portion which will be referred to herein as a register or buffer, and where the sampled values are temporarily stored while the processor can continue to operate on them, namely to determine whether the values in question should be outputted or not. The acquisition unit can be configured to keep track of the information of which data originates from which port, which can allow it to track contextual information pertaining to the values. The acquisition unit can also have a clock which can allow to track contextual information pertaining to the values, namely the time at which the associated real-time samplings were taken.

Concerning the first of these contextual elements, one way of keeping track of what the values relate to is to dedicate different portions of the register, which will be referred to herein as “channels”, to different sources of values. For instance, values originating from different sensors can be stored in different channels, and each one of the channels can be associated to a corresponding sensor ID, in which case the acquisition unit can append the sensor ID to the value before outputting the value. Another way of keeping track of what the values relate to is to store the values as part of data items which may also include a parameter ID encoding what the value relates to, in addition to a timestamp, for instance. Such as in the example presented in FIG. 2. The function of appending parameter IDs and/or timestamps can be performed based on instructions stored in the memory and referred to as a contextualizer. The function of outputting the data can be performed based on instructions stored in the memory and referred to as an application programming interface (API).

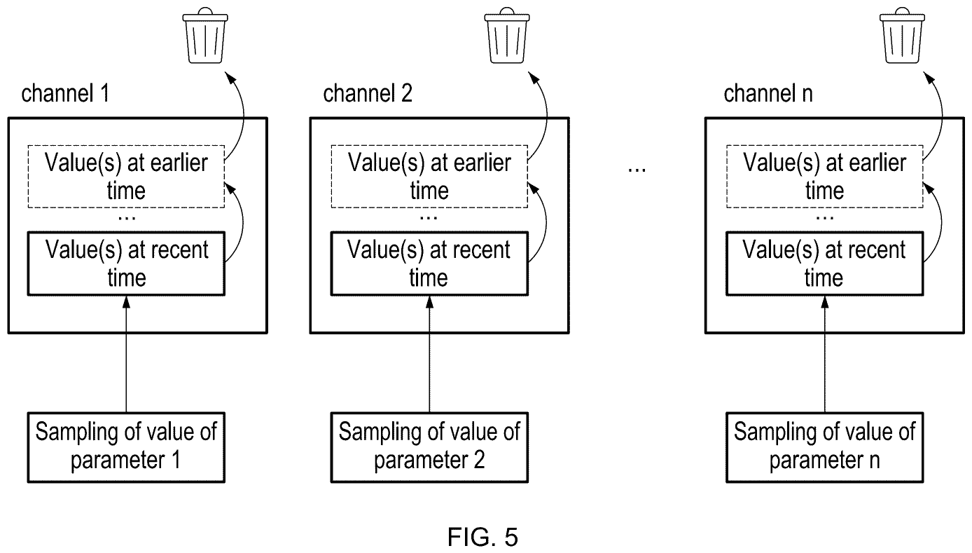

Referring to FIG. 5, each registered channel can store one or more values of a given parameter at a recent point in time (i.e., one or more recent values), and one or more values of the same parameter at an earlier point in time (i.e., one or more earlier values). The one or more recent values may be overwritten, in the channel of the register, by new values at a rate corresponding to the sampling rate. In one embodiment, recent values can be copied in a manner to overwrite earlier values prior to being overwritten. The sampling rate can be of more than 1 value per minute, and even more than one value per second. Accordingly, the function of determining whether a difference between the one or more recent values and the one or more earlier values exceeds the expected variation range or not can be performed while the values in question are in the register, prior to overwriting, and can be repeated at a regular “refresh” rate, which can correspond to the sampling rate for instance, or be a rate lower than the sampling rate.

Referring back to FIG. 4, the function of determining whether a difference between the one or more recent values and the one or more earlier values exceeds the expected variation range or not can be performed by a set of instructions stored in the memory and collectively referred to as a variability determiner, based on data contained in the registers, and on variation threshold data, also stored in the memory, and encoding expected variation ranges for different ones of the parameters. The variation threshold data can be in the form of a table with one row listing expected variation ranges and another row listing parameter IDs. Alternatively, the variation ranges may be more dynamic and influenced to some degree by some variables which may be embodied as values stored in the registers, or the variation ranges may be the same for a plurality of parameters, for instance.

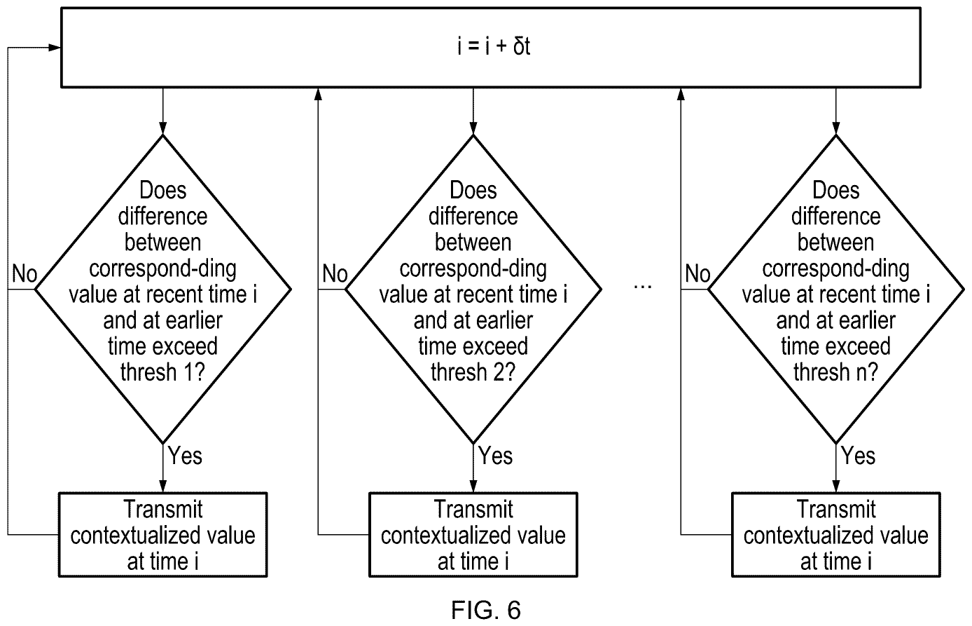

FIG. 6 presents a simplified flow chart illustrating an example of the operation of the variation determiner. In this figure, the value 1 represents a value in arbitrary units corresponding to the time delay between samplings. The operations of determining whether the differences between one or more recent values and one or more earlier values exceed the corresponding expected variation ranges are performed in parallel, or in close sequence, for the different channels, and repeated each time a new value replaces the preceding value in the channels of the buffer over successive iterations i, based on the repetition i=i+δt. At every interaction i, there is a possibility that one or more of the values corresponding to different parameters would exceed the corresponding expected variation ranges, in which cases these one or more values would be triggered for output/transmission, in a contextualized manner, such as with a 1^{st} level contextualization. Such contextualized values can be stored in a data store of a server, for instance, for further data processing or analysis. There is also a possibility that one or more of the values corresponding to different parameters do not exceed the corresponding variation ranges, in which cases these values are not transmitted/outputted. The values which are not transmitted/outputted may then be overwritten with fresh values and stored neither in the acquisition unit nor outside of the acquisition unit. These same possibilities repeat at every iteration i.

FIG. 6 is referred to as a “simplified” flow chart because in practice, the parallel steps of determining whether the difference exceeds the expected variation range may each involve first calculating the difference and then comparing the difference to the corresponding expected variation range. The expression “corresponding” in the last sentence refers to comparing the differences between values of a same parameter to the expected variation range for that same parameter. Alternately, for instance, determining whether the difference exceeds the expected variation range may involve determining a maximum value, a minimum value, or both, for the one or more recent values based on the one or more earlier values and the expected variation range, and then computing whether the one or more recent values exceed the maximum value (e.g., is greater than the maximum value), the minimum value (e.g., is lesser than the minimum value), or both. The outputting/transmitting of the values may take place in real time, e.g., at the refresh rate, or a limited data store may be included in the acquisition unit, allowing to accumulate a list of values to be outputted/transmitted, and the actual output/transmission may be triggered regularly, or sporadically (e.g., when the data store is full), for a group of data items corresponding to different points in time to be transmitted together. Typically, one would not want to delay the transmission/output of data from the acquisition unit by more than a few seconds, or by more than a few minutes.

There are different ways of implementing this function in practice. Referring back to the example presented in FIG. 5, the function of sampling values of different parameters can be performed at a regular rate and can involve overwriting the latest value at recent time. The different channels can be first-in first-out buffers, for instance, and the overwriting of the latest value at a recent time may automatically trigger the copying of the latest value at recent time to a value at earlier time slot in the buffer, in which case the preceding value at earlier time can become overwritten by the new value. In some embodiments, there may be only two slots in each channel, and determining whether the difference exceeds the expected variation range may simply involve determining the difference between the values in the two slots and comparing the difference to the corresponding expected variation range. In another example embodiment, there may still be only two value slots in the different channels of the register, but the value in the “recent time” slot may only be copied into (and overwrite the preceding value in) the “earlier time” slot when the difference between the values in the two slots is determined to exceed the corresponding expected variation range, in which case the value in the earlier time slot may also be transmitted/outputted. The latter approach can avoid situations where progressive drifting at a very slow rate could otherwise escape detection.

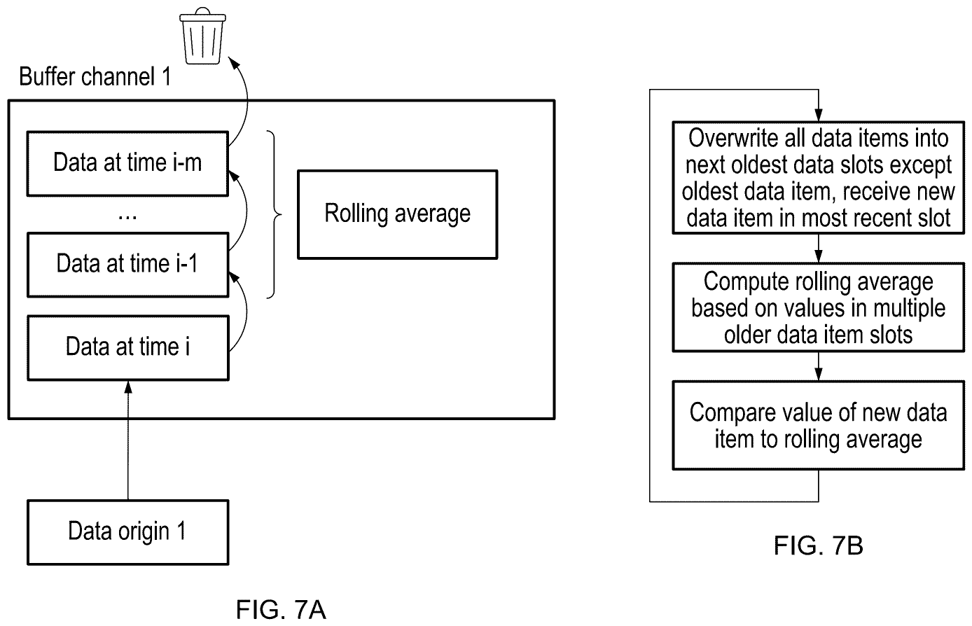

In yet other examples, such as schematically illustrated in FIGS. 7A and 7B, there may be more than two slots per channel. For instance, there may be three or more slots in each channel which may operate as first-in first-out buffers. The three or more slots can include a group of one or more recent values, and a group of one or more earlier values. In some cases, differences between each value and each other value may be calculated, and the output of a value can be triggered when any one of the differences calculated exceeds the expected variation range. In some other cases, one or more additional slots may be used to store rolling averages. Rolling averages, e.g., averages which are recalculated at the sampling rate, can be stored in corresponding slots for one or both groups, and, depending on the embodiment, the difference can be calculated between a unique value and a rolling average, or between a rolling average of recent values and a rolling average of earlier values. Still other embodiments are possible, such as determining a minimum or maximum value, or both, of values in one or more groups of slots, and comparing a unique value to such a minimum or maximum, or comparing a minimum or maximum of one group to a minimum or maximum of another group, to name still yet other examples. All the above-identified examples can be said to include calculating a difference between one or more recent values and one or more earlier values.

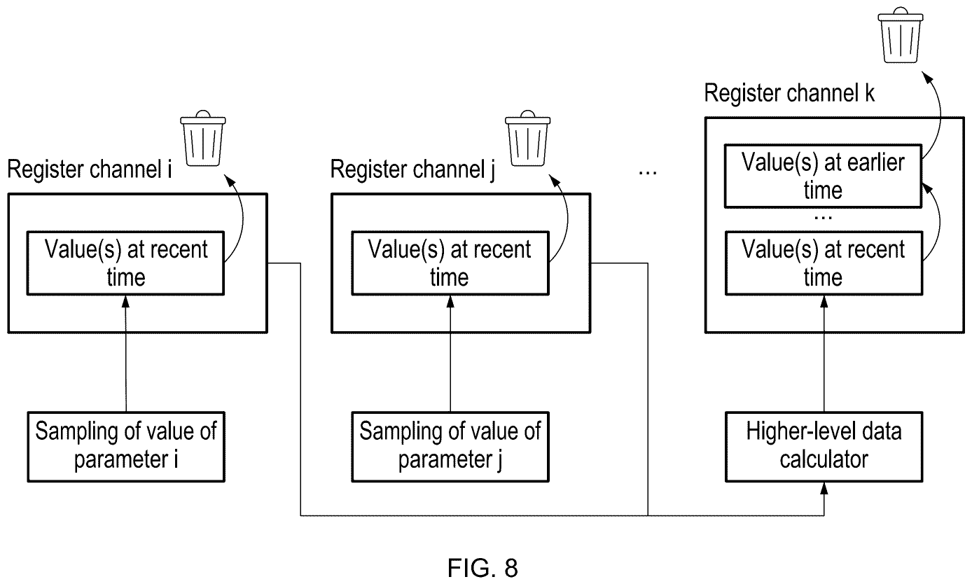

It will also be noted, with reference to FIG. 8, that while FIG. 5 presents an example embodiment where the sources of values are specifically samplings of corresponding parameters, such as sensor signals corresponding to different sensor IDs, other embodiments are possible. Indeed, embodiments are possible where some, or all, of the sources of values for the different channels are calculations instead of samplings, and the calculations may yield values which can alternately be referred to as “composite” values. The relevance of this approach will appear even clearer when considering further explanations which will be presented below, associated with benefits of “compressing” larger amounts of data which have a lesser degree of relevance for the purpose of analysis of the behavior of large electric rotary machines into smaller amounts of data which have a higher degree of relevance. But first, let us look into an example of how this can be accomplished.

In the example in FIG. 8, two or more channels, such as channels i and channel j, are dedicated to receiving time-varying values of corresponding lower-level parameters, such as values sampled from different sensors. Instructions stored in the memory of the acquisition unit and which will be referred to herein as the higher-level data calculator, can calculate values of a higher-level parameter based on values in one or more lower-level channels, and push the resulting time-varying calculated values into a dedicated channel. Such a dedicated channel is labeled k in FIG. 8. The calculation of new values by the higher-level data calculator can be performed at a rate corresponding to the refreshing rate of parameters i and j, for instance, which, in turn, can correspond to a sampling rate of the acquisition unit for the corresponding sensors.

One or more higher-level data channels, such as channel k, may constitute channels such as channels 1, 2 and n of FIG. 5, and operate in a similar manner. In other words, a difference between one or more recent values of the higher-level parameter k and one or more earlier values of the higher-level parameter k may be calculated, and the difference can be compared to a corresponding expected variation range, in a process which may be repeated such as illustrated in FIG. 6, wherein only the values which have been determined to be the source of a difference greater than the expected variation range are transmitted/outputted in a contextualized manner from the acquisition unit. In the specific example of FIG. 8, the channels i and j storing the values of the lower-level parameters may have a single slot, and each new value may thus directly overwrite and delete the earlier value at the sampling range, and these channels may not form the basis of a comparison between a difference in values and an expected variation range. In an alternate embodiment, register channels i and j may instead be like channels 1 and 2 of FIG. 5, and also form the basis of a comparison between a difference in values and an expected variation range, in addition to the comparison between a difference in values and an expected variation range performed for the values of the parameter k which is calculated from the values of the parameters 1 and 2. Various alternative embodiments are possible.

Three tangible examples of higher-level parameters will be detailed below for illustrative purposes. But before then, let us better look at the performance gains which the use of such higher-level parameters may entail. Indeed, it will be understood that operating in the mode of transmitting only values which have been determined to vary more than the expected variation range by default may lead to large amounts of data being transmitted in certain transient conditions, which may carry a mix of advantages and inconveniences. For instance, one can imagine a scenario where samplings are triggered by thresholds set in an alarm system, but where the machine operators close the alarm system, and thus the automated sampling triggers, at startup and shut down, to avoid being overwhelmed by numerous alarms which may be considered irrelevant. In this scenario, data pertaining to the starting or shutting down conditions of the rotary electric machine may not be made available to the analysts, for the sole reason that the triggers to acquire the data are typically deactivated by the machine operators. Accordingly, using a method such as presented above in which only data which varies beyond the expected variation range is transmitted, can allow obtaining data pertaining to these transient starting or shutting-down conditions, and may be perceived as an advantage. Moreover, the inconveniences of such large amounts of data at such periods of time can be alleviated by using certain techniques which can allow the compressing of larger amounts of lower-level data into smaller amounts of higher-level data. The higher-level data may be more relevant from the point of view of analysis than the lower-level data and occupy less memory space or bandwidth. The compressing can be performed by the acquisition unit itself, in real-time or near real-time, such that in some cases, it transmits the smaller amount of higher-level data instead of the larger amount of lower-level data, when the data is determined to have varied outside the expected variation range. In such cases, the comparison between the one or more recent values and the one or more earlier values can be based on either the lower-level data or the higher-level data. In some cases, it may be preferred to perform the determination of whether the difference between subsequent values exceeds an expected variation range based on the higher-level data itself, in which case the calculations may be performed repeatedly on values contained in the channels associated to the lower-level parameters, such as at the sampling rate. In some other cases, basing the comparison on the lower-level data may be preferred to save the processing of the higher-level data to situations where the higher-level data is used/transmitted.

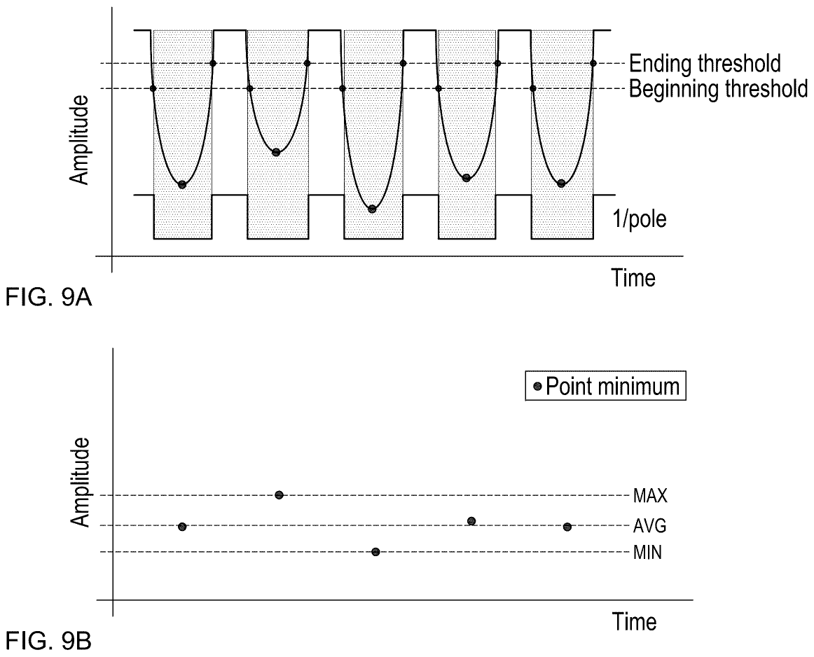

FIGS. 9A and 9B present a first example of calculating higher-level data based on lower-level data. In this example, the higher-level data pertains to the minimum distance between the rotor poles and the stator, which can be referred to as the “minimum point per pole”. The functions associated with making these calculations can be referred to as the minimum point per pole module and may form part of the higher-level data calculator. The data pertaining to the minimum point per pole can be useful during analysis for operations such as calculating and monitoring the shape of the rotor, calculating and monitoring the shape of the stator by using the minimum point of a pole measured by all sensors distributed on a stator (e.g., minimum 4 sensors), calculating the circularity and concentricity of the rotor and/or stator, monitoring the variation of the minimum point per pole for each pole for each turn, etc.

Let us take an example of a MW range hydroelectric generator which has 22 poles and where one revolution lasts 138.33 ms at nominal speed. At each revolution, each sensor may sample 1833 values over the 183.33 ms, whereas the minimum point for 1 revolution may correspond to 22 of these 1833 values per revolution. In addition to the sensors which measure the distances, this calculation can further be based on a synchronization sensor, sometimes referred to as “synchro”, which can have the purpose of determining the beginning and the end of each revolution of the machine. After the signal indicating the beginning of a turn of the machine is received by the minimum point per pole module, the module can detect the beginning of a pole based on the pole beginning threshold shown in FIG. 9A. The module may then store, in the memory, the smallest value sampled by the sensor between the pole beginning threshold and a pole ending threshold. The beginning threshold and the ending threshold may be configurable. Once the pole ending threshold has been reached, the module can associate the smallest value to the pole ID and increment the pole ID. The pole ID can be reset to 1 based on the synchro signal. The result for each pole/sensor can be a limited collection of higher-level data values corresponding to the minimum points such as shown by dots in FIG. 9B, whereas the continuous sampling of the values by the corresponding sensor forming a quasi-continuous line, such as shown in FIG. 9A, may form a greater volume of lower-level data. When outputted, the minimum points per pole can be identified as minimum points for a given pole, as opposed to simply a value outputted by a given sensor coupled to the corresponding pole.

It will be noted that an additional time series collapsed only into binary values of 1 or 0, can be calculated by the minimum point per pole module. Indeed, this additional time series can be labeled 1/pole and convey only the information of when a pole beginning threshold has been reached, and when a pole ending threshold has been reached, providing information of when the sensor is in rough alignment with a pole. Another way of making a similar time series is to use the values of time for which minimum values were obtained in the method presented above.

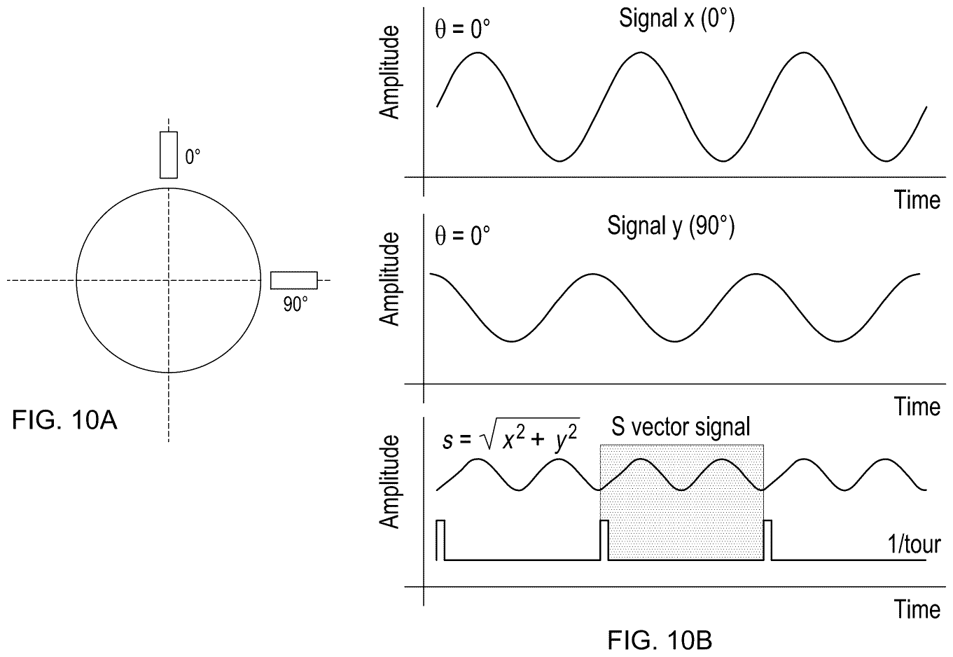

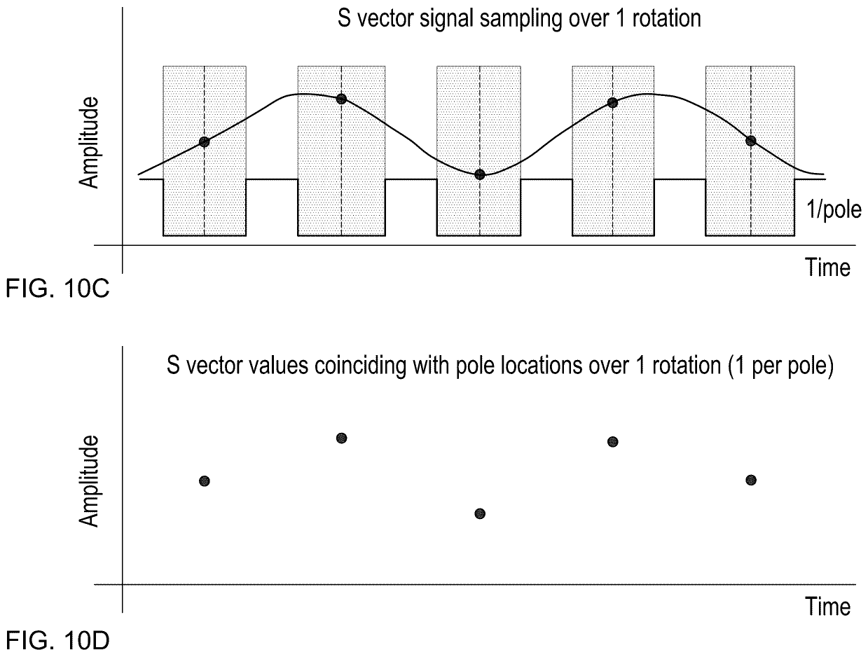

FIGS. 10A, 10B, 10C and 10D present a second example of calculating higher-level data based on lower-level data. In this example, data pertains to the displacement of the shaft of the large rotary electric machine. Indeed, when calculating circularity and concentricity of the stator and rotor, the S-vector, which indicated the direction of displacement of the shaft, is useful. The amplitude of the S vector at the centers of the poles can be particularly relevant. A module may be configured to make these calculations and may form part of the higher-level data calculator. The module can calculate the s vector on each sample of two sensors. These calculations can factor in the 1/pole compressed time series introduced above to calculate the amplitude of the s vector per pole.

Let us take an example of a MW range hydroelectric generator which has 22 poles and where one revolution lasts 183.33 ms at nominal speed. At each revolution, the number of values of calculated S vector values, when performed at the sampling rate, can be of 1833 values over the 183.33 ms, whereas the S vector at 1 point/pole can bring this down to 22 of these 1833 values per revolution.

FIG. 10A presents a schematic cross-sectional view showing the position of the sensors. Referring to FIG. 10B, to calculate the s vector, two proximity sensors configured such as shown in FIG. 10A can be used to determine the displacement of the shaft of the machine. To maximize contrast, the two sensors can be positioned at 90° from one another, though trigonometrical relationships can be used to calculate results based on angles other than 90°. In the example such as presented in FIG. 10A, the sensor placed at 0° can show displacement on the x axis, whereas the sensor placed at 90° can show displacement on the y axis. In FIG. 10B, the upper graph shows displacement along the x axis, and the middle graph shows the displacement along the y axis, over three successive rotations. The s vector can correspond to the square root of the sum of the squared displacement in the x axis and the squared displacement in the y axis and is illustrated in the bottom graph.

FIG. 10C is a graphical representation of the s vector time series in combination with the 1/pole time series. Combining these two time series, one can identify the moments in time where the s vector time series corresponds to alignment with a pole. The module may then store, in the memory, a single value of the s vector for each period of alignment with a pole, such as the value of the s vector for the position/time corresponding to the minimum distance. Accordingly, the result can be a limited collection of higher-level data values corresponding to the points represented by dots in FIG. 10D, whereas the continuous sampling of the values by the corresponding sensor forms quasi-continuous lines in the upper and middle portions of FIG. 10B may form a greater volume of lower-level data. When outputted, the one value per pole s vector can be identified as such a parameter, as opposed to two sequences of values identified as having been outputted by a corresponding proximity sensor provided at the corresponding angles relative to the shaft.

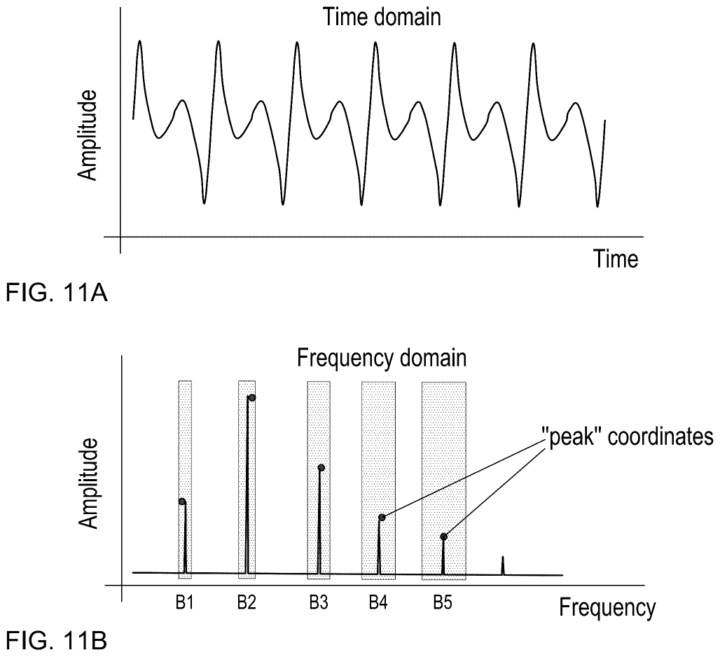

FIGS. 11A and 11B present a third example of calculating higher-level data based on lower-level data. In this example, the data pertains to signals generated by vibration sensors. In the data sampled from such sensors, certain elements may be more relevant for analysis than others, such as the fundamental frequency of the machine, the harmonic frequencies, and the sub-harmonic frequencies. A module may be configured to make these calculations and may form part of the higher-level data calculator. The module can transform the temporal signal into a frequential signal. Frequencies of interest can be extracted via frequency bands. The higher-level data extracted from the calculations may include only the frequency and amplitude of the highest amplitude point within a given frequency band.

Let us take an example of a temporal signal of 10 seconds at 10 kilosamples per second (ksps). Sampling this signal can yield 100 000 values. The extracted values for 5 frequency bands can include only 10 values, including 2 values per frequency band: frequency and amplitude at the point of maximum amplitude in the band.

FIG. 11A presents an example of the temporal signal, whereas FIG. 11B presents its Fourier transform, or otherwise said, the same signal but depicted in the frequency domain instead of in the time domain. A fast fourier transform (FFT) algorithm can be used to perform the conversion. In the frequency domain signal, bands can be defined to correspond to frequencies of interest. The information pertaining to the frequency and amplitude at the point of maximum amplitude can be extracted within each band.

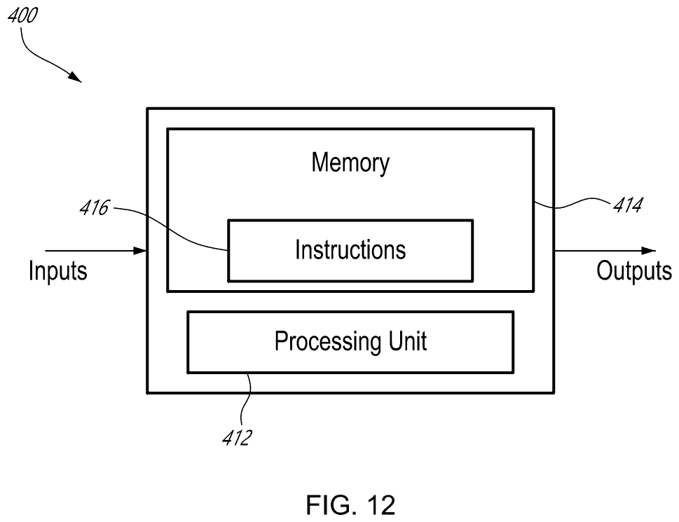

Referring to FIG. 12, it will be understood that the expression “computer” 400 as used herein is not to be interpreted in a limiting manner. It is rather used in a broad sense to generally refer to the combination of some form of one or more processing units 412 and some form of memory system 414 accessible by the processing unit(s). The memory system can be of the non-transitory type. The use of the expression “computer” in its singular form as used herein includes within its scope the combination of a two or more computers working collaboratively to perform a given function. Moreover, the expression “computer” as used herein includes within its scope the use of partial capabilities of a given processing unit.

A processing unit can be embodied in the form of a general-purpose micro-processor or microcontroller, a digital signal processing (DSP) processor, an integrated circuit, a field programmable gate array (FPGA), a reconfigurable processor, a programmable read-only memory (PROM), to name a few examples.

The memory system can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computer can have one or more input/output (I/O) interface to allow communication with a human user and/or with another computer via an associated input, output, or input/output device such as a keybord, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switched telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions. Different elements of a computer, such as processor and/or memory, can be local, or in part or in whole remote and/or distributed and/or virtual.

As can be understood, the examples described above and illustrated are intended to be exemplary only. The scope is indicated by the appended claims.

What is claimed is:

1. An acquisition unit comprising:
input ports connectable to receive signals from sensors coupled to an electric machine having a peak power of at least 100 kW;
one or more output ports;
a clock;
a memory storing parameter IDs of different parameters of the electric machine, channels corresponding to different ones of the parameter IDs, variation data including one or more expected variation ranges for the different parameter IDs, and instructions;
a hardware processor which executes the instructions to, in sequence:
acquire values for the parameter IDs based on the signals from the sensors, including writing the values in corresponding ones of the channels based on the parameter IDs;
for each of one or more of the channels,
determine whether a difference between one or more recent ones of the values and one or more earlier ones of the values for a corresponding one of the parameter IDs exceeds a corresponding one of the expected variation ranges, and
output the one or more recent ones of the values, contextualized with a timestamp and the corresponding one of the parameter IDs, contingent upon the difference exceeding the corresponding one of the expected variation ranges;
refresh the values in the channels including repeat said acquire values; and
repeat in sequence said determine and said output for said each of one or more of the channels, and said refresh.

2. The acquisition unit claim 1 wherein said acquire values further includes acquire values for a lower-level one of the different parameters directly from the signals, and compute values for a higher-level one of the different parameters based on the values acquired for the lower-level one of the different parameters.

3. The acquisition unit of claim 2 wherein said one or more of the channels includes a channel corresponding to one of the parameter IDs associated to the lower-level one of the different parameters.

4. The acquisition unit of claim 2 wherein said one or more of the channels includes a channel corresponding to one of the parameter IDs associated to the higher-level one of the different parameters.

5. The acquisition unit of claim 2 wherein the higher-level one of the different parameters is a minimum point of a pole parameter, and the lower-level one of the different parameters is an airgap at a pole, and wherein said compute values for the minimum point of a pole parameter includes detecting a beginning threshold airgap at the pole, detecting an ending threshold airgap at the pole, and detecting a minimum airgap in the values for the airgap at a pole acquired between the detected beginning threshold airgap at the pole and the ending threshold airgap at the pole.

6. The acquisition unit of claim 2 wherein the higher-level one of the different parameters is an s vector of a shaft of the electric machine parameter, the lower-level one of the different parameters is a proximity to the shaft at a first angle parameter, wherein said acquire values further includes acquire values for a proximity to the shaft at a second angle parameter, and wherein said compute values for the s vector of a shaft of the electric machine parameter is based on the values of the first lower-level parameter and on the values of the second lower-level parameter.

7. The acquisition unit of claim 6 wherein said acquire values further includes acquire values for an airgap at a pole parameter, and compute values for an indication of proximity to the pole parameter including detecting a beginning threshold airgap at the pole and an ending threshold airgap at the pole.

8. The acquisition unit of claim 7 wherein said acquire values further includes compute values for a one s vector value per pole parameter including identifying a single value of the s vector per proximity to a pole parameter based on the indication of proximity to a pole parameter and the s vector of a shaft of the electric machine parameter.

9. The acquisition unit of claim 2 wherein said acquire values further includes acquire values of one or more of a displacement, displacement speed, and acceleration parameter, and compute values for a frequency peak parameter including performing a Fourier transform of time-series data of one or more of the one or more of the displacement, displacement speed, and acceleration parameter to produce frequency-domain data, and identifying a frequency and an amplitude of one or more peaks in the frequency-domain data.

10. The acquisition unit of claim 1 wherein said determine includes determine whether a difference between one recent value and one earlier value of the corresponding parameter ID exceeds the expected variation range for the corresponding parameter ID.

11. The acquisition unit of claim 1 wherein said determine includes calculate a difference between the one or more recent values of the values and the one or more earlier values, and compare the difference with the expected variation range.

12. The acquisition unit of claim 11 wherein said calculate includes calculating an average of at least one of the one or more recent values and of the one or more earlier values, and said compare is based on the at least one average.

13. The acquisition unit of claim 12 wherein said refresh further includes progressing the values in a first-in, first out basis.

14. The acquisition unit of claim 1, wherein said refresh includes overwrite the one or more earlier values with the one or more recent values contingent upon having determined that the difference exceeded the expected variation range.

15. The acquisition unit of claim 14, further comprising determining at least one or a maximum and a minimum value for each of any outputted ones of the one or more recent values based on the expected variation range for the corresponding parameter ID, and wherein said determine includes computing whether the one or more recent values exceed the at least one of a maximum and a minimum value.

16. The acquisition unit of claim 1 wherein said refresh is performed at a sampling rate of less than one minute, preferably less than one second.

17. The acquisition unit of claim 16 further comprising repeatedly outputting, at the sampling rate, the values for different ones of the channels having been associated to a difference greater than the corresponding expected variation range, while not outputting the values for different ones of the channels having been associated to a difference lesser than the corresponding expected variation range.

18. The acquisition unit of claim 1 wherein the variation data includes different values of expected variation ranges for different ones of the parameters, and is formatted as a table including expected variation range and parameter ID.

19. The acquisition unit of claim 1 wherein the channels are defined in registers of the memory.

20. The acquisition unit of claim 1 wherein said determine and output is performed in parallel for different ones of the channels.

21. The acquisition unit of claim 1 further comprising transmitting the values for different ones of the channels having been associated to a difference greater than the corresponding expected variation range in the form of data items including corresponding timestamps and parameter IDs, via a local area network.

22. A method of monitoring an electric machine located at a facility, the method comprising:
writing values of different parameters of the electric machine in different channels of a memory including sampling signals received from sensors coupled to the electric machine, and writing one or more recent values a corresponding parameter in each channel;
obtaining one or more earlier values of the different parameters;
obtaining variation threshold data pertaining to expected variation ranges for the different parameters;
for each of one or more of the channels,
determining whether a difference between the one or more recent values of the values and one or more earlier values of a corresponding parameter ID exceeds an expected variation range for the corresponding parameter ID, and
triggering the transmission of the one or more recent values, contextualized with a timestamp and a parameter ID, contingent upon the difference exceeding the corresponding expected variation range;
refreshing the one or more recent values in the channels based on subsequent sampling of the signals; and
repetitively repeating said determining and said triggering for each of the one or more of the channels and said refreshing.

23. The method of claim 22 wherein the memory is a memory of an acquisition unit, further comprising: transmitting the one or more the one or more recent values, contextualized with a timestamp and a parameter ID, contingent upon the difference exceeding the corresponding expected variation range; writing the transmitted one or more recent values in a memory of a server computer; computing, at the server computer, one or more values of a parameter pertaining to a state of operation of the electric machine, including at least one of rotation speed, temperature and magnetic field, based at least on the transmitted one or more recent values stored in the memory of the server computer.
